(19) United States
(12) Patent Application Publication
(10) Pub. No.: US 2024/0141215 A1
(43) Pub. Date: May 2, 2024

(54) FLAME-RETARDANT HOT MELT PRESSURE SENSITIVE ADHESIVE COMPOSITION, AND METHODS AND ARTICLES INCLUDING THE SAME

(71) Applicant: H.B. Fuller Company, St. Paul, MN (US)

(72) Inventors: Boran Zhao, Woodbury, MN (US); Sydne M. Kreitz-Still, St. Paul, MN (US); James N. Hammond, Minneapolis, MN (US); James E. Welton, Coon Rapids, MN (US)

(21) Appl. No.: 18/498,785

(22) Filed: Oct. 31, 2023

Related U.S. Application Data
(60) Provisional application No. 63/381,708, filed on Oct. 31, 2022.

(51) Int. Cl. C09J 153/02; C09J 7/38; C09J 11/04; C09J 11/06; C09J 11/08

(52) U.S. Cl. CPC C09J 153/025; C09J 7/387; C09J 11/04; C09J 11/06; C09J 11/08; C09J 2203/33; C09J 2301/302; C09J 2301/312; C09J 2301/408; C09J 2301/414

(57) ABSTRACT

A flame-retardant hot melt pressure sensitive adhesive composition that includes styrenic block copolymer, tackifying agent, phosphinic acid salt, polyphosphate, optionally an intumescent agent, and optionally plasticizer.

### CROSS REFERENCE TO RELATED APPLICATIONS

This application claims the benefit of U.S. Provisional Application No. 63/381,708, filed Oct. 31, 2022, which is incorporated herein by reference.

### BACKGROUND

The invention is directed to flame-retardant hot melt pressure sensitive adhesive compositions.

Hot melt pressure sensitive adhesive compositions are often applied using a spray applicator. However, for a hot melt pressure sensitive adhesive compositions to be capable of being applied using a spray application technique, the viscosity of the composition must be sufficiently low at the application temperature, i.e., the temperature of the composition at the point it is release from the applicator head.

Hot melt pressure sensitive adhesive compositions are solid at room temperature, melt when heated, and are flammable.

Flame-retardant agents frequently are in the form of solid particles. When solid particles are added to a hot melt adhesive composition, the solid particles cause an increase in the viscosity of the composition. Solid particles also can negatively impact the adhesive properties of an adhesive composition.

There is a need for a flame-retardant hot melt pressure sensitive adhesive composition that exhibits good adhesive properties and a sufficiently low viscosity such that it can be applied using commercially available hot melt spray applicators. In some applications, there is a need for a flame-retardant hot melt pressure sensitive adhesive composition that is free from halogenated flame-retardant agents.

### SUMMARY

In one aspect, the invention features a flame-retardant hot melt pressure sensitive adhesive composition that includes styrenic block copolymer, tackifying agent, phosphinic acid salt, and polyphosphate, the flame-retardant hot melt pressure sensitive adhesive composition passing the Flammability I and Flammability II test methods.

In another aspect, the invention features a flame-retardant hot melt pressure sensitive adhesive composition that includes styrenic block copolymer, tackifying agent, phosphinic acid salt, and polyphosphate, the hot melt pressure sensitive adhesive composition exhibiting a viscosity no greater than 20,000 centipoise (cP), or even no greater than 15,000 cP, at 177° C.

In one embodiment, the flame-retardant hot melt pressure sensitive adhesive composition further includes plasticizer.

In another embodiment, the polyphosphate includes a polyphosphate having a melting point no greater than 120° C. In other embodiments, the polyphosphate includes a first polyphosphate and a second polyphosphate different from the first polyphosphate, the second polyphosphate having a melting point no greater than 120° C.

In some embodiments, the phosphinic acid salt includes organic phosphinate salt. In other embodiments, the phosphinic acid salt includes a diethyl phosphinate salt.

In one embodiment, the flame-retardant hot melt pressure sensitive adhesive composition further includes an intumescent agent, the intumescent agent being different from the polyphosphate. In some embodiments, the polyphosphate includes ammonium polyphosphate and the intumescent agent includes a melamine derived intumescent agent.

In other embodiments, the flame-retardant hot melt pressure sensitive adhesive composition further includes a component selected from the group consisting of metal oxide, carbon black, expandable graphite, and combinations thereof. In some embodiments, the component is selected from the group consisting of aluminum trihydrate, magnesium hydroxide, titanium dioxide, zinc borate, carbon black, and combinations thereof.

In one embodiment, the styrenic block copolymer includes a radial styrenic block copolymer, a maleic anhydride modified styrene-ethylene-butylene-styrene block copolymer, or a combination thereof.

In another embodiment, the flame-retardant hot melt pressure sensitive adhesive composition includes from 5% by weight to 35% by weight styrenic block copolymer, from 5% by weight to 40% by weight phosphinic acid salt, from 3% by weight to 40% by weight polyphosphate, and from 10% by weight to 65% by weight tackifying agent.

In other embodiments, the flame-retardant hot melt pressure sensitive adhesive composition includes from 10% by weight to 30% by weight styrenic block copolymer, from 5% by weight to 30% by weight phosphinic acid salt, from 5% by weight to 30% by weight polyphosphate, from 10% by weight to 65% by weight tackifying agent, and from 5% by weight to 30% by weight plasticizer.

In some embodiments, the flame-retardant hot melt pressure sensitive adhesive composition includes from 10% by weight to 30% by weight styrenic block copolymer, wherein the styrenic block copolymer includes a radial block copolymer, from 5% by weight to 30% by weight phosphinic acid salt, from 5% by weight to 30% by weight polyphosphate, intumescent agent different from the polyphosphate, from 10% by weight to 65% by weight tackifying agent, and from 5% by weight to 30% by weight plasticizer.

In one embodiment, the flame-retardant hot melt pressure sensitive adhesive composition includes from 10% by weight to 30% by weight styrenic block copolymer, wherein the styrenic block copolymer includes a radial block copolymer, from 5% by weight to 30% by weight phosphinic acid salt, from 5% by weight to 30% by weight polyphosphate, an intumescent agent different from the polyphosphate, from 10% by weight to 65% by weight tackifying agent, from 5% by weight to 30% by weight plasticizer, and a flame retardant selected from the group consisting of metal oxide, carbon black, and combinations thereof.

In another embodiment, the polyphosphate includes a first polyphosphate and a second polyphosphate different from the first polyphosphate, the second polyphosphate having a melting point no greater than 120° C., and the intumescent agent is different from the first polyphosphate and the second polyphosphate.

In one embodiment, the sum of the weight of the phosphinic acid salt and the weight of the polyphosphate is no greater than 40% by weight based on the weight of the flame-retardant hot melt pressure sensitive adhesive composition. In another embodiment, the sum of the weight of the phosphinic acid salt and the weight of the polyphosphate is no greater than 30% by weight based on the weight of the flame-retardant hot melt pressure sensitive adhesive composition.

In other embodiments, the composition exhibits a peel force of at least 1.16 N/cm when tested according to the 180 Degree Peel Adhesion test method.

In some embodiments, the composition exhibits a maximum debonding force of at least 2.94 N when tested according to the Loop Tack test method.

In one embodiment, the composition has a shear adhesion failure temperature of at least 50° C.

In another embodiment, the composition passes the Flammability I test method. In other embodiments, the composition passes the Flammability II test method. In some embodiments, the composition passes the Flammability I and Flammability II test methods.

In one embodiment, the composition exhibits a viscosity no greater than 8000 cP, or even no greater than 6000 cP, at 177° C.

In another aspect, the invention features a process for applying a flame-retardant hot melt pressure sensitive adhesive composition on a battery cell, the process includes releasing the flame-retardant hot melt pressure sensitive adhesive composition from an applicator head in the form of a spray, and forming an adhesive coated surface on a surface of a first battery cell, the forming including contacting the surface of a battery cell with the spray of the flame-retardant hot melt pressure sensitive adhesive composition without the applicator head contacting the surface of the battery cell. In one embodiment, the process further includes contacting the adhesive coated surface of the first battery cell with an adhesive coated surface of a second battery cell to adhere the first battery cell to the second battery cell. In another embodiment, the process further includes contacting the adhesive coated surface of the first battery cell with an exterior surface of a second battery cell to adhere the first battery cell to the second battery cell. In some embodiments, the first battery cell includes a pouch comprised of a multilayer film includes a first outer film layer, the first outer film layer includes nylon, polyethylene terephthalate, or polypropylene, and the spray of adhesive composition contacts the first outer film layer. In one embodiment, the spray of adhesive composition is in a form selected from the group consisting of fibers, foam, spiral pattern, and combinations thereof.

In other aspects, the invention features a battery cell array that includes a first battery cell, a second battery cell, and a flame-retardant pressure sensitive hot melt adhesive composition disclosed herein, the first battery cell being adhered to the second battery cell through the flame-retardant pressure sensitive hot melt adhesive composition.

The invention features a hot melt pressure sensitive adhesive composition that exhibits good adhesion, good flame-retardant properties, and can be applied using a spray application method.

Other features and advantages will be apparent from the following description of the preferred embodiments and from the claims.

### Glossary

In reference to the invention, these terms have the meanings set forth below:

The term “Flame-Retardant” means the ability to slow down the propagation of fire.

The term “Intumesce” means to expand in volume and char when exposed to a high temperature or a flame.

The term “hot melt pressure sensitive adhesive composition” means a pressure sensitive adhesive composition that is solid at room temperature and flows when heated.

### DETAILED DESCRIPTION

The flame-retardant hot melt pressure sensitive adhesive composition includes a styrenic block copolymer, tackifying agent, phosphinic acid salt, and a polyphosphate. The flame-retardant hot melt pressure sensitive adhesive composition intumesces when exposed to a flame. Preferably the flame-retardant hot melt pressure sensitive adhesive composition passes at least one of the UL 94 VO test method and the UL 510A test method, and more preferably passes both the UL 94 VO and the UL 510A test methods. The flame-retardant hot melt pressure sensitive adhesive composition preferably is free of components having a flash point less than 121° C. The flame-retardant hot melt pressure sensitive adhesive composition preferably is free of halogenated flame retardant agents and can be formulated to be free of halogenated flame retardant agents and pass at least one of the UL 94 VO test method and the UL 510A test method.

The flame-retardant hot melt pressure sensitive adhesive composition can be formulated to exhibit any suitable viscosity including, e.g., no greater than 50,000 centipoise (cP), no greater than 20,000 cP, no greater than 15,000 cP, no greater than 10,000 cP, no greater than 8,000 cP, no greater than 6,000 cP, at least 500 cP, at least 1000 cP, from 2000 cP to 15,000 cP, from 2000 cP to 6000 cP, from 2000 cP to 5000 cP, or even from 3000 cP to 6000 cP at 177° C. One useful flame-retardant hot melt pressure sensitive adhesive composition exhibits a viscosity no greater than 10,000 centipoise (cP) at 177° C., or even no greater than 6000 cP at 177° C.

The flame-retardant hot melt pressure sensitive adhesive composition is tacky to the touch at room temperature and preferably exhibits sufficient adhesive and sufficient cohesive strength to maintain two substrates in fixed relation to each other. Useful measures of adhesive and cohesive strength include Loop Tack, 180° Peel adhesion and Shear Adhesion Failure Temperature. Particularly useful flame-retardant hot melt pressure sensitive adhesive compositions exhibit a maximum debonding force of at least 300 grams of force (gf) (2.94 Newtons (N)), at least 700 gf (6.86 N), at least 1000 gf (9.8 N), at least 2000 gf (19.6 N), or even at least 3000 gf (29.4 N) when tested according to the Loop Tack test method, a 180° peel force of at least at least 300 gf/inch (gf/in) (1.16 Newtons/centimeter (N/cm)), at least 500 gf/in (1.93 N/cm), or even at least 700 gf/in (2.7 N/cm) when tested according to the 180° Peel Adhesion test method, a shear adhesion failure temperature of at least 50° C., at least 60° C., or even at least 65° C. when tested according to the Shear Adhesion Failure Temperature (SAFT) test method, or a combination of these properties.

Styrenic Block Copolymer

The flame-retardant hot melt pressure sensitive adhesive composition includes a styrenic block copolymer and preferably includes at least one radial styrenic block copolymer. Styrenic block copolymers are derived from styrenic monomer and at least one comonomer, and the monomers are present in blocks.

The styrenic block copolymer includes at least one styrenic end block (A), at least one midblock (B), and optionally a maleic anhydride graft modification. The styrenic block copolymer can exhibit any structure including, e.g., linear, radial, and star-shaped structures including, e.g., a styrenic diblock copolymer of the formula A-B, a linear triblock copolymer of the formula A-B-A, a linear A-(B-A)n-B multi-block copolymer formula, a linear tetrablock copolymer formula, e.g., A-B-A-B, and a pentablock copolymer having a A-B-A-B-A formula, a multi-arm block copolymer of the formula (A-B)nY, and combinations thereof, where A is a monoalkenyl arene block, B is a conjugated diene or sesquiterpene block, Y is a multivalent compound, and n is an integer of at least 3.

Useful styrenic end blocks (A) include, e.g., styrene, alpha-methylstyrene, o-methylstyrene, m-methylstyrene, p-methylstyrene, ethyl styrene, propyl styrene, butyl styrene, p-tert-butylstyrene, 2,4-dimethylstyrene, 2,4,6-trimethylstyrene, vinyl toluene, 1,1-vinyl biphenyl, vinyl naphthalene, vinyl anthracene, and combinations thereof.

Useful classes of midblock (B) include, e.g., elastomeric conjugated dienes (e.g., hydrogenated and nonhydrogenated conjugated dienes), sesquiterpenes (e.g., hydrogenated and nonhydrogenated sesquiterpenes), and combinations thereof. Suitable conjugated dienes include, e.g., butadiene (e.g., polybutadiene), isoprene (e.g., polyisoprene), 2,3-dimethyl-1,3-butadiene, 1,3-pentadiene, 1,3-hexadiene, 1-phenyl-1,3-butadiene, 3-butyl-1,3-octadiene, myrcene, farnesene, 1,3-cyclohexadiene, piperylene, and combinations thereof, and hydrogenated versions thereof including, e.g., ethylene, propylene, butylene and combinations thereof (e.g., ethylene/butylene and ethylene/propylene). Suitable sesquiterpenes include, e.g., beta farnesene. The midblock can additionally include monomer units or blocks derived from monomer units that are identified above as being useful for the styrenic end blocks (A) including, e.g., styrene.

Useful styrenic block copolymers include, e.g., radial styrene-butadiene block copolymers, random styrene-butadiene block copolymers, styrene-butadiene block copolymers, multi-armed styrene-butadiene block copolymers, styrene-butadiene block copolymers, styrene-butadiene-styrene block copolymers, styrene-isobutylene-styrene block copolymers, styrene-isoprene block copolymers, styrene-isoprene-styrene block copolymers, styrene-multiarmed styrene-isoprene (SI)x block copolymers, hydrogenated styrenic block copolymers (e.g., styrene-ethylene-butylene-styrene, styrene-ethylene-propylene-styrene, styrene-ethylene-butylene-styrene-styrene, styrene-ethylene-ethylene-propylene-styrene, styrene-ethylene-butylene-styrene-styrene, and combinations thereof), maleic anhydride modified styrenic block copolymers (e.g., maleic anhydride modified styrene-ethylene-butylene-styrene block copolymers, maleic anhydride modified styrene-ethylene-propylene-styrene block copolymers, maleic anhydride modified styrene-isoprene-styrene block copolymers, and maleic anhydride modified styrene-butadiene-styrene block copolymers), and combinations thereof.

Useful styrenic block copolymers are commercially available under the KRATON D and G series of trade designations from Kraton Corporation (Houston, Texas) including, e.g., KRATON D 1124 branched styrene-isoprene block copolymer, D 1163 linear styrene-isoprene-styrene block copolymer, D 1117 linear styrene-isoprene-styrene block copolymer, and KRATON G 1652 styrene-ethylene-butylene-styrene block copolymer and G 1726 styrene-ethylene-butylene-styrene block copolymer, under the SOLPRENE and CALPRENE series of trade designations from Dynasol Elastomeros, Corp. (Tamaulipas, Mexico) including SOLPRENE 1205, SOLPRENE 411, and CALPRENE 401 radial styrenic block copolymers, under the EUROPRENE Sol T trade designation from EniChem (Houston, Texas), under the FINAPRENE series of trade designations from Total Petrochemicals USA (Houston, Texas), including FINAPRENE 401, under the SEPTON series of trade designations from Septon Company of America (Pasadena, Texas) including SEPTON S 1001 styrene-ethylene-propylene-styrene block copolymer, and SEPTON 4030, 4033, 4044, 4055 and 4077 block copolymers, under the VECTOR series of trade designations from Taiwan Synthetic Rubber Corporation (Taipei City, Taiwan) including VECTOR 4211A and VECTOR 4411A styrene-isoprene-styrene block copolymers, under the TAIPOL series of trade designations from Taiwan Synthetic Rubber Corporation including TAIPOL 7126 maleic anhydride modified styrene-ethylene-butylene-styrene block copolymer and TAIPOL 7131 maleic anhydride modified styrene-ethylene-butylene-styrene block copolymer, under the FG trade designations from Kraton Corporation including FG 1901 maleic anhydride modified styrene-ethylene-butylene-styrene block copolymer, and under the M trade designations from Asahi Kasei Corp. (Tokyo, Japan) including M 1913 maleic anhydride modified styrene-ethylene-butylene-styrene block copolymer.

The composition includes from 5% by weight to 35% by weight, from 5 by weight to 30% by weight, from 10% by weight to 30% by weight, or even from 15% by weight to 30% by weight styrenic block copolymer,

The composition preferably includes from 0% by weight to 20% by weight, from 2% by weight to 20% by weight, from 2% by weight to 15% by weight, or even from 5% by weight to 15% by weight radial styrenic block copolymer.

Tackifying Agent

The tackifying agent can be solid or liquid at room temperature and the composition can include combinations of solid and liquid tackifying agents. Useful classes of tackifying agents include, e.g., aromatic, aliphatic, and cycloaliphatic hydrocarbon resins, mixed aromatic and aliphatic modified hydrocarbon resins, aromatic modified aliphatic hydrocarbon resins, and hydrogenated versions thereof; terpenes, modified terpenes and hydrogenated versions thereof; natural rosins, modified rosins, rosin esters, and hydrogenated versions thereof; and combinations thereof.

Useful classes of hydrocarbon resins include, e.g., branched, unbranched, and cyclic C5 resins, C9 resins, C10 resins, C5/C9 resins, hydrogenated C5 resins, hydrogenated C9 resins, hydrogenated dicyclopentadiene (DCPD), and combinations thereof.

Useful hydrocarbon tackifying agents are commercially available under a variety of trade designations including, e.g., the PLASTOLYN and ENDEX series of trade designations from Synthomer PLC (London, United Kingdom) including PLASTOLYN 290 aromatic hydrocarbon resin and ENDEX 160 HC aromatic hydrocarbon resin having a Ring and Ball softening point of 159° C., the HF series of trade designations from Henghe Materials & Science Technology Co., Ltd. (Ningbo, China) including HF-100, the ESCOREZ series of trade designations from ExxonMobil Chemical Company (Houston, Texas) including ESCOREZ 1310LC, ESCOREZ 5400, ESCOREZ 5415, ESCOREZ 5600, ESCOREZ 5615, ESCOREZ 5637, and ESCOREZ 5690, the EASTOTAC series of trade designations from Synthomer PLC (London, United Kingdom) including EASTOTAC H-100R, EASTOTAC H-100L, EASTOTAC H-100W, and EASTOTAC H130W, the WINGTACK series of trade designations from Cray Valley HSC (Exton, Pennsylvania) including WINGTACK 86 aromatically modified, C-5 hydrocarbon resin, WINGTACK EXTRA aromatically modified, C-5 hydrocarbon resin, WINGTACK 95 aliphatic C-5 petroleum hydrocarbon resin, WINGTACK 10 liquid aliphatic resin, and the PICCOTAC series of trade designations from Synthomer PLC (London, United Kingdom) including, e.g., PICCOTAC 8095 aromatically modified, C-5 hydrocarbon resin and 1115 hydrocarbon resin, the ARKON series of trade designations from Arakawa Europe GmbH (Germany) including, e.g., ARKON P-100 hydrogenated hydrocarbon resin and ARKON P-125 alicyclic saturated hydrocarbon resin, the RESINALL trade designation from Resinall Corp. (Severn, North Carolina) including RESINALL 1030 hydrogenated hydrocarbon resin, and the REGALITE and REGALREZ series of trade designations from Eastman Chemical Company including, e.g., REGALITE R1125 fully hydrogenated hydrocarbon resin and REGALREZ 1126 hydrocarbon resin.

Useful rosin-based tackifying agents include rosin acids, rosin esters, wood rosin, tall oil rosin, gum rosin, distilled rosin, hydrogenated rosin, dimerized rosin, polymerized rosin, and combinations thereof. Examples of useful rosin esters include e.g., glycerol esters of pale wood rosin, glycerol esters of hydrogenated rosin, glycerol esters of polymerized rosin, pentaerythritol esters of natural and modified rosins including pentaerythritol esters of pale wood rosin, pentaerythritol esters of hydrogenated rosin, pentaerythritol esters of tall oil rosin, phenolic-modified pentaerythritol esters of rosin, and combinations thereof.

Useful commercially available rosin-based tackifying agents are available under a variety of trade designations including, e.g., the SYLVALITE and SYLVATAC series of trade designations from Kraton Corporation (Houston, Texas) including, e.g., SYLVALITE RE-100L rosin ester, SYLVALITE 9100 rosin ester, and SYLVATAC RE 25 rosin ester, KOMOTAC KA100L gum rosin pentaerythritol ester from Komo Pine Chemicals, Guangzhou Komo Chemical Co., Ltd. (China), the WESTREZ and ALTATAC series of trade designations from Ingevity Corp. (North Charleston, South Carolina) including, e.g., WESTREZ 5101, WESTREZ 5295, and ALTATAC 1000 rosin esters, the FORAL series of trade designations from Eastman (Kingsport, Tennessee) including, e.g., FORAL 105-E gum rosins and FORAL AX rosin acid, and the TECKROS series of trade designations from Teckrez Inc. (Fleming Island, Florida) including, e.g., TECKROS D85 and D95 rosin esters.

Examples of useful polyterpene resins include terpene phenolic resins, non-hydrogenated polyterpene resins, hydrogenated polyterpene resins, and copolymers and terpolymers of natural terpenes (e.g., styrene-terpene, alpha-methyl styrene-terpene and vinyl toluene-terpene), and combinations thereof. Polyterpene resins are commercially available under a variety of trade designations including, e.g., the SYLVARES series of trade designations from Kraton Corp. (Houston, Texas) including SYLVARES 6100 terpene resin and SYLVAREZ TRM1115 polyterpene resin, and under the DERCOLYTE series of trade designations from DRT Company (Dax, France) including, e.g., DERCOLYTE A115 terpene resin.

The composition includes from 10% by weight to 65% by weight, from 15% by weight to 55% by weight, or even from 25% by weight to 50% by weight tackifying agent.

Phosphinic Acid Salt

Useful phosphinic acid salts include organic phosphinate salts, inorganic phosphinic acid salts, diphosphinic acid salts, and combinations thereof. Useful metal ions of the phosphinic acid salts are derived from a variety of metals including, e.g., alkali metals, alkaline earth metals, transition metals, post transition metals, metalloids, and combinations thereof including, e.g., lithium, sodium, potassium, magnesium, calcium, titanium, manganese, iron, zinc, zirconium, aluminum, germanium, tin, antimony, and bismuth.

Useful organic phosphinate salts include alkyl and dialkyl phosphinate salts including, e.g., aluminum dialkyl phosphinate (e.g., aluminum diethyl phosphinate).

Useful inorganic phosphinic acid salts include, e.g., aluminum phosphinate salt and zinc phosphinate salt.

The phosphinic acid salt preferably has a median particle diameter of no greater than 50 microns (μm), no greater than 20 μm, no greater than 15 μm, or even no greater than 10 μm.

Useful phosphinic acid salts are commercially available under a variety of trade designations including, e.g., under the EXOLIT series of trade designations from Clariant Corporation (Germany) including EXOLIT OP 945 aluminum diethyl phosphinate, EXOLIT OP 930 phosphinate, EXOLIT OP 935 phosphinate, EXOLIT OP 1311 phosphinate, EXOLIT OP 1248 phosphinate, and EXOLIT OP 1230 phosphinate.

The composition includes from 5% by weight to 40% by weight, from 5% by weight to 30% by weight, from 5% by weight to 20% by weight, or even from 10% by weight to 20% by weight phosphinic acid salt.

Polyphosphate

The polyphosphate is a salt or an ester of phosphoric acid that includes at least two phosphate units in a linear or cyclic structure. Useful salts of phosphoric acid include a cationic moiety (e.g., ammonia, melamine, and combinations thereof). The flame-retardant hot melt pressure sensitive adhesive composition preferably includes at least one polyphosphate that exhibits a melt temperature no greater than 120° C., or even no greater than 110° C.

Useful polyphosphates include, e.g., ammonium polyphosphate, melamine polyphosphate, hexaphenoxycyclotriphosphazene, and combinations thereof.

Specific examples of suitable polyphosphate esters include phosphate tetrakis(2,6-dimethylphenyl)-m-phenylene bis phosphate, resorcinol bis(diphenyl phosphate) (RDP), bisphenol A bis(diphenyl phosphate), biphosphate resorcinol bis(dixylenyl phosphate), and combinations thereof.

The polyphosphate preferably has a median particle diameter of no greater than 50 μm, no greater than 20 μm, no greater than 15 μm, or even no greater than 10 μm.

Useful polyphosphates are commercially available under a variety of trade designations including, e.g., PHOSGARD series of trade designations from St. Louis Group LLC (Indianapolis, Indiana) including PHOSGARD 200 phosphate tetrakis(2,6-dimethylphenyl)-m-phenylene bis phosphate, PHOSGARD 300 polyphosphate flame retardant system reported by the manufacturer as having a phosphorous content from 28% to 32%, PHOSGARD 700 polyphosphate and nitrogen flame retardant system reported by the manufacturer as having a phosphorous content from 17% to 22% and a nitrogen content from 21% to 23%, PHOSGARD APP-HP ammonium polyphosphate flame retardant reported by the manufacturer as having a phosphorous content of at least 31% and a nitrogen content from 14% to 15%, MELAPUR melamine polyphosphate from BASF Group (Florham Park, New Jersey), and FYROFLEX series of trade designations from ICL-Industrial Products Group Ltd. (Israel) including FYROFLEX RDP-HP resorcinol bis(diphenyl phosphate) reported by the manufacturer as having a phosphorous content of 10.7% by weight and FYROFLEX SOL-DP a phosphate ester flame retardant reported by the manufacturer as having a phosphorous content of 10.7% by weight.

The flame-retardant hot melt pressure sensitive adhesive composition includes at least 3% by weight, at least 5% by weight, from 3% by weight to 40% by weight, from 3% by weight to 30% by weight, from 5% by weight to 30% by weight, from 3% by weight to 15% by weight, or even from 3% by weight to 10% by weight polyphosphate, and optionally from 0% by weight to 20% by weight, from 3% by weight to 20% by weight, from 5% by weight to 15% by weight, or even from 5% by weight to 10% by weight of a polyphosphate having a melt temperature no greater than 120° C., or even no greater than 110° C.

Optional Additional Components

The composition optionally includes additional components including, e.g., intumescent agents, additional flame-retardant components, plasticizers, stabilizers, antioxidants, additional polymers, adhesion promoters, ultraviolet light stabilizers (e.g., TINUVIN P from BASF Corporation), rheology modifiers, corrosion inhibitors, colorants (e.g., pigments and dyes), fillers, fragrances, additional flame retardants, and combinations thereof.

Intumescent Agent

Useful intumescent agents decompose (or sublime), releases gas, and increase in volume upon exposure to a flame, a temperature greater than 200° C., or both. Preferred intumescent agents decompose at a temperature of at least 220° C. or even at least 250° C. One useful class of intumescent agents includes melamine derived intumescent agents including, e.g., melamine (i.e., 1,3,5-triazine-2,4,6-triamine), melam (i.e., (N2-(4,6-diamino-1,3,5-triazin-2-yl)-1,3,5-triazine-2,4,6-triamine), melem (i.e., 2,5,8-triamino-tri-s-triazine), melon (i.e., H(—C₆N₈H₂)—NH—)₁₀(NH₂)), melamine phosphate, melamine pyrophosphate, melamine polyphosphate, melam polyphosphate, melem polyphosphate, melon polyphosphate, melamine cyanurate, and combinations thereof. Other useful intumescent agents include, e.g., dicyanoguanidine, phthalocyanine pigment, diazo compounds, expandable graphite, and combinations thereof.

Useful intumescent agents are commercially available under a variety of trade designations including, e.g., under the CHARFLAM series of trade designations from St. Louis Group LLC (Indianapolis, Indiana) including CHARFLAM 200 melamine polyphosphate, and CHARFLAM 400, CHARFLAM 400W and CHARFLAM 400D, which include 1,3,5-triazine-2,4,6(1H,3H,5H)-trione and 1,3,5-triazine-2,4,6-triamine at a 1:1 ratio, and under the GRAFGUARD series of trade designations from NeoGraf Solutions, LLC (Lakewood, Ohio) including GRAFGUARD 200, 210, 220, 225, 250, and 280 expandable graphite flakes.

The flame-retardant hot melt pressure sensitive adhesive composition includes from 0% by weight to 30% by weight, from 5% by weight to 20% by weight, or even from 5% by weight to 10% by weight of an intumescent agent that is different from the polyphosphate.

Additional Flame Retardant Component

Useful additional flame-retardant components include, e.g., metal oxides (e.g., anhydrous metal oxides, metal hydroxides, and metal hydrates), carbon black, and combinations thereof. Suitable metal oxide flame retardants are derived from a variety of elements including, e.g., aluminum, boron, calcium, magnesium, zinc, tin, titanium, cerium, and combinations thereof. Useful metal oxide flame retardants include, e.g., magnesium hydroxide, titanium dioxide, zinc borate, zinc carbonate, zinc stannate, zinc hydrogen phosphate, zinc pyrophosphate, zinc oleate, zinc stearate, zinc phosphate, and combinations thereof.

Useful metal oxide flame retardants are commercially available under a variety of trade designations including, e.g., FIREBRAKE ZB zinc borate fire retardant and FIREBRAKE 500 anhydrous zinc borate fire retardant both of which are available from U.S. Borax Inc (Boron, California).

Useful metal hydrate flame retardants include, e.g., aluminum trihydrate, zinc borate, and combinations thereof.

The flame-retardant hot melt pressure sensitive adhesive composition includes from 0% by weight to 10% by weight, from 0.1% by weight to 10% by weight, from 0.1% by weight to 5% by weight, or even from 0.1% by weight to 2% by weight of these optional flame-retardant components.

Plasticizer

Useful plasticizers include liquid plasticizers (i.e., a plasticizer that is liquid at room temperature), solid plasticizers, and combinations thereof. Useful classes of liquid plasticizers include, e.g., oils, oligomeric and low molecular weight polymeric plasticizers, and combinations thereof. Useful oils include, e.g., hydrocarbon oil, mineral oil (e.g., white mineral oil), paraffinic oil, naphthenic oil, gas to liquid oil, synthetic liquid oligomers of polyolefins (e.g., oligomers of polypropylene, polybutene, polyisoprene, and hydrogenated polyisoprene), liquid polyisobutylene, polybutadiene, glycerol esters of fatty acids, polyesters (e.g., polyethylene glycol di-2-ethylhexoate ester), hydrocarbon fluids, benzoate esters (e.g., ethylene glycol dibenzoate, propylene glycol dibenzoate, diethylene glycol dibenzoate, dipropylene glycol dibenzoate, pentaerythritol tetrabenzoate), and derivatives thereof, and combinations thereof, oils derived from renewable resources (e.g., animal oil, plant oil (e.g., canola oil, corn oil, soybean oil, epoxidized soybean oil, palm oil, peanut oil, olive oil, sunflower oil, rapeseed oil, jatropha oil, coconut oil, and castor oil), and combinations thereof. One example of a class of useful solid plasticizers is benzoate esters.

Suitable commercially available liquid plasticizers are available under a variety of trade designations including, e.g., KN40410 naphthenic oil from Lube Oil Company of Petro China (Beijing, China), CALSOL 5550 naphthenic oil and DRAKEOL 35 paraffinic oil from Calumet Specialty Products (Indianapolis, Indiana), NYFLEX 222B and NYFLEX 223 naphthenic oils from Nynas Naphthenic AB (Sweden) and Dry #1 castor oil from Vertellus Performance Materials Inc. (Bayonne, New Jersey), PURETOL 35 paraffinic oil from Petro-Canada Lubricants Inc. (Ontario, Canada), CATENEX T145 paraffinic oil from Shell Oil Products US (Houston, Texas), KAYDOL mineral oil from Sonneborn (Petrolia, Pennsylvania), KRYSTOL 550 mineral oil from Petrochem Carless Limited (Surrey, England), RISELLA X430 natural gas to liquid oil from Shell Oil Products US (Houston, Texas), BENZOFLEX 284, BENZOFLEX 9-88, and BENZOFLEX 2088 benzoate plasticizers from Eastman Specialties Holdings Corp. (Kingsport, Tennessee), HALLGREEN R-8010 renewable ester, PARAPLEX A-8000, and PARAPLEX A-8200 all from Hallstar Industrial (Chicago, Illinois), and DYNACOLL 7250 and DYNACOLL 7230 polyester polyols from Evonik Industries AG (Essen, Germany).

One example of a suitable commercially available solid plasticizer is BENZOFLEX 352 benzoate ester plasticizer, which is available from Eastman Specialties Holdings Corp. (Kingsport, Tenn.).

The composition includes from 0% by weight to 30% by weight, from 5% by weight to 30 by weight, or even from 5% by weight to 20% by weight plasticizer.

Antioxidant

Useful antioxidants include, e.g., pentaerythritol tetrakis[3,(3,5-di-tert-butyl-4-hydroxyphenyl)propionate], 2,2′-methylene bis(4-methyl-6-tert-butylphenol), phosphites including, e.g., tris-(p-nonylphenyl)-phosphite (TNPP) and bis(2,4-di-tert-butylphenyl)4,4′-diphenylene-diphosphonite, di-stearyl-3,3′-thiodipropionate (DSTDP), and combinations thereof. Useful antioxidants are commercially available under a variety of trade designations including, e.g., the IRGANOX series of trade designations including, e.g., IRGANOX 1010, IRGANOX 565, and IRGANOX 1076 hindered phenolic antioxidants, and IRGAFOS 168 phosphite antioxidant, all of which are available from BASF Corporation (Florham Park, New Jersey). When present, the composition preferably includes from about 0.02% by weight to about 2% by weight antioxidant.

Uses

The composition is useful in a variety of forms including, e.g., bead, spray pattern, coating (e.g., continuous coatings and discontinuous (e.g., random, pattern, and array) coatings), film (e.g., continuous films and discontinuous films), binder, fiber (e.g., random fiber), and foam. The composition can be applied at any desirable thickness. Formulations of the flame-retardant hot melt pressure sensitive adhesive composition that exhibit a sufficiently low viscosity can be applied using spray applicator equipment to achieve a relatively thin coating thickness including, e.g., coating thicknesses of no greater than 200 microns (μm), no greater than 100 μm, 20 um, 30 um, from 20 μm to 100 μm, from 20 μm to 50 μm, or even from 20 μm to 30 μm.

The hot melt adhesive composition can be applied to or incorporated in a variety of substrates including, e.g., films (e.g., polyolefin (e.g., polyethylene and polypropylene) films, polyester films (e.g., polybutylene terephthalate and polyethylene terephthalate), polyamide films (e.g., Nylon, Nylon 6, Nylon 66, Nylon 610, Nylon 612, Nylon 1,6, Nylon 510, and copolymers thereof), and polyimide films), release liners, metals (e.g., stainless steel and aluminum), metal foils (e.g., aluminum foil and stainless steel foil), foams (e.g., polyurethane foam in a variety of forms including sheets), and sheets (e.g., mica sheets), and can be used to bond one or more substrates together including, e.g., stainless steel to stainless steel, polyethylene terephthalate to polyethylene terephthalate, polyethylene terephthalate to stainless steel, polyethylene terephthalate to mica sheet, polyethylene to polyethylene terephthalate, polypropylene to polyethylene terephthalate, polyamide to polyamide, polyethylene terephthalate to metal foil (e.g., aluminum foil), stainless steel to metal foil (e.g., aluminum foil), polyethylene to polyethylene, polyethylene to polypropylene, polypropylene to polypropylene, mica sheet to polyurethane foam, and combinations thereof.

The flame-retardant hot melt pressure sensitive adhesive composition is also useful for bonding components within a battery pack. In one embodiment, the flame-retardant hot melt pressure sensitive adhesive composition is useful for adhering two battery cells together. In one embodiment, the flame-retardant hot melt pressure sensitive adhesive composition is applied to the outer surface of a first battery cell, and optionally the adhesive coated first battery cell contacts a second battery cell (which is optionally also coated with the same or different flame-retardant hot melt pressure sensitive adhesive composition) to adhere the two battery cells together, preferably preventing the battery cells from moving relative to one another. An array of multiple battery cells adhered together can be formed in this way.

Suitable battery cells include a hermetically sealed casing that accommodates an electrolyte and an electrode assembly. One useful class of sealable casings includes pliable polymer laminates (e.g., a multilayer film laminate). The pliable polymer laminate includes at least one outer polymer film layer, at least one interior metal foil layer (e.g., aluminum foil), and at least one inner polymer film layer. Both the outer and inner polymer layers include a single layer of polymer film and optionally include multiple layers of polymer film. Each polymer film layer is formed from the same or different polymer and, optionally, blends of different polymers. Suitable polymers for forming the outer polymer layer include, e.g., polyamides (e.g., Nylon, Nylon 6, Nylon 66, Nylon 610, Nylon 612, Nylon 1,6, Nylon 510, and copolymers thereof), polyimides, polyester (e.g., polybutylene terephthalate and polyethylene terephthalate), polyolefins (e.g., polyethylene and polypropylene), and combinations thereof.

Suitable polymers for forming the inner polymer layer include, e.g., polypropylene and polyethylene.

The interior metal foil layer includes at least one metal foil layer and optionally includes multiple metal foil layers, optionally separated by at least one polymer film layer. Preferred metal foil layers are aluminum. Other suitable metal foil layers include, e.g., stainless steel.

The battery and the pliable polymer laminate exhibit any suitable structure including, e.g., a pouch, a cylinder, a prism, a coin-like shape, and combinations thereof.

The flame-retardant hot melt pressure sensitive adhesive composition is also useful for adhering a battery or an array of batteries to a housing (e.g., a container) where the battery or array of batteries is adhered to the housing through the flame-retardant hot melt pressure sensitive adhesive composition. The housing can be of any suitable material including, e.g., metal (e.g., aluminum and stainless steel), plastic (e.g., polyethylene terephthalate, polyurethane, and polycarbonate), and combinations thereof.

The invention will now be described by way of the following examples. All parts, ratios, percentages, and amounts stated in the Examples are by weight unless otherwise specified.

### EXAMPLES

### Test Procedures

Test procedures used in the examples include the following. All ratios and percentages are by weight unless otherwise indicated. The procedures are conducted at room temperature (i.e., an ambient temperature of from about 20° C. to about 25° C.) unless otherwise specified.

### Flammability I Test Method: UL 94 VO Test Method

Flammability is determined according to UL 94 entitled, “Standard for Safety Tests for Flammability of Plastic Materials for Parts in Devices and Appliances” (2013) using a sample thickness of 3 millimeters (mm). The results are reported as pass or fail.

### Flammability II Test Method: UL 510A Test Method

Flammability is determined according to UL 510A entitled, “Standard for Safety Component Tapes”. The results are reported as pass or fail.

Viscosity Test Method

Viscosity is determined in accordance with ASTM D-3236 entitled, “Standard Test Method for Apparent viscosity of Hot Melt Adhesives and Coating Materials” (Apr. 1, 2015), using a Brookfield Thermosel viscometer Model RVDV 2 and a SC4-27 spindle at a temperature of 177° C., with the exception that the measurement is taken in a torque range from 30% to 70%. The results are reported in centipoise (cP).

### 180° Peel Test Method

The 180° peel force is determined according to ASTM D 3330-02 entitled, “Standard Test Method for Peel Adhesion of Pressure-Sensitive Tape” using two 50 micron (μm) polyethylene terephthalate films. The results are reported in units of gram force per inch (gf/in) or Newtons per centimeter (N/cm).

### 90° Peel Test Method

The 90° peel force is determined according to ASTM D 3330-02 entitled, “Standard Test Method for Peel Adhesion of Pressure-Sensitive Tape” test method F using two 50 micron (μm) polyethylene terephthalate films. The results are reported in units of gram force per inch (gf/in) or Newtons per centimeter (N/cm).

### Shear Adhesion Failure Temperature (SAFT) Test Method

The shear adhesion failure temperature is determined according to ASTM D 4498-00 entitled, “Standard Test Method for Heat-Fail Temperature in Shear of Hot Melt Adhesives” using two 50 μm polyethylene terephthalate films. The results are reported in units of degrees Celsius (° C.).

### Loop Tack Test Method

Loop tack is determined according to ASTM D 6195-03 entitled, “Standard Test Method for Loop Tack” using two 50 μm polyethylene terephthalate films. The maximum debonding force is reported in units of grams of force (gf) or Newtons (N), and the failure mode is recorded as adhesive, cohesive, or transfer.

### Examples 1-5

The hot melt pressure sensitive adhesive compositions of Examples 1-5 were prepared as follows: the components of the compositions of Examples 1-5 that were non-melting were combined with components of the composition that are liquid at room temperature in a high speed mixer and mixed under vacuum for about one minute to form a dispersion. The block copolymer and the antioxidants were combined at room temperature and added to a sigma blade mixer, which had been pre-heated to an oil heater set point of 185° C. The components were then heated and mixed under a nitrogen blanket to a temperature sufficient to melt the components (i.e., from 150° C. to 190° C.) to form a molten composition. Then about a third of the tackifier and components that had relatively low melt temperature were added to the molten block copolymer compositions and mixed until homogeneous. This process was repeated until all components were added and the mixture was homogeneous. Then the dispersion was added to the molten composition, and the composition was mixed at a temperature of from 150° C. to 190° C. to form the adhesive composition. The amounts of the components in each composition set forth in Tables 1, 2, and 3 are in percent by weight.

The resulting hot melt pressure sensitive adhesive compositions of Examples 1-5 were then tested according to the Viscosity, Flammability I and II, Loop Tack, 180° Peel, and SAFT test methods (where indicated). The viscosity was measured at 20 rotations per minute. The results are set forth below in Tables 1-3.

The compositions of Examples 4 and 5 were additionally tested according to A) the 180° Peel Test Method with the exceptions that 1) the first film was polyethylene terephthalate (PET) and the second substrate was stainless steel (SS), and 2) the first film was PET and the second substrate was a mica sheet, and B) the 90° Peel Test Method with the exceptions that the first sheet was a mica sheet and the second substrate was a polyurethane foam, as indicated in Table 3.

TABLE 1

| Example 1 | % By Weight |
|---|---|
| PLASTOLYN 290 | 1.2 |
| SOLPRENE 1205 | 1.2 |
| VECTOR 4211A | 6.5 |
| CALSOL 5550 | 12.0 |
| ESCOREZ 5600 | 19.7 |
| SOLPRENE 411 | 1.8 |
| KRATON D1124 | 6.1 |
| FINAPRENE 401 | 3.0 |
| ESCOREZ 5400 | 19.1 |
| ENDEX 160 HC | 2.8 |
| IRGANOX 1010 | 0.4 |
| IRGANOX 1076 | 0.4 |
| PHOSGARD 200 | 4.8 |
| PHOSGARD 300 | 3.6 |
| PHOSGARD 700 | 4.8 |
| EXOLIT OP 945 | 11.4 |
| FIREBRAKE ZB | 1.2 |
| Viscosity at 177° C. (cP) | 11,360 |
| Flammability I: UL 94 V0 | Pass |
| Flammability II: UL 510A | Pass |
| Loop Tack (gf) | 2200 |
| 180 Degree Peel (gf/in) | 4700 |
| SAFT (° C.) | 68 |

PLASTOLYN 290 = aromatic hydrocarbon resin (Synthomer PLC, London, United Kingdom)
SOLPRENE 1205 = linear random styrene-butadiene block copolymer 30% styrene (Dynasol Group, Houston, Texas)
VECTOR 4211A = styrene-isoprene-styrene block copolymer (Taiwan Synthetic Rubber Corporation, Taipei City, Taiwan)
CALSOL 5550 = naphthenic oil (Calumet Specialty Products Partners, LP, Indianapolis, Indiana)
ESCOREZ 5600 = aromatic modified cycloaliphatic hydrocarbon resin having a softening point from 100° C. to 106° C. (ExxonMobil Corporation)
SOLPRENE 411 = 70/30 butadiene/styrene thermoplastic radial copolymer (Dynasol Group, Houston, Texas)
KRATON D1124 = branched styrene-isoprene copolymer having a polystyrene content of 30% (Kraton Corporation, Houston, Texas)
FINAPRENE 401 = radial 22%/78% styrene-butadiene block copolymer (PetrochemicalsUSA, Houston, Texas)
ESCOREZ 5400 = cycloaliphatic hydrocarbon resin (ExxonMobil Chemical, Houston, Texas
ENDEX 160 HC = aromatic hydrocarbon resin having a Ring and Ball softening point of 159° C. (Synthomer PLC, London, United Kingdom)
IRGANOX 1076 = antioxidant
IRGANOX 1010 = antioxidant
PHOSGARD 200 == phosphate tetrakis(2,6-dimethylphenyl)-m-phenylene bis phosphate flame retardant that is solid at room temperature and has a melt temperature of 95° C.
PHOSGARD 300 = polyphosphate flame-retardant system (St. Louis Group LLC, Indianapolis, Indiana)
PHOSGARD 700 = polyphosphate and nitrogen flame-retardant system (St. Louis Group LLC)
PHOSGARDAPP-HP = ammonium polyphosphate flame retardant (St. Louis Group LLC)
EXOLIT OP 945 = aluminum diethyl phosphinate fine grain powder (Clariant Plastics & Coatings, Germany)
FIREBRAKE ZB = zinc borate (U.S. Borax Inc., Boron, California).

TABLE 2

| Example 2 | % by weight |
|---|---|
| ESCOREZ 5400 | 25.0 |
| SYLVAREZ TRM1115 | 4.0 |
| ENDEX 160 H2 | 3.0 |
| KAYDOL | 15.0 |
| KRATON D1117 | 22.0 |
| IRGANOX 1076 | 0.5 |
| IRGANOX 1010 | 0.5 |
| EXOLIT OP 945 | 10.0 |
| PHOSGARD 200 | 16.0 |
| CHARFLAM 400D | 4.0 |
| Viscosity (cP) | 8000 |
| Flammability I: UL 94 V0 | Pass |
| Flammability II: UL 510A | Pass |
| Loop Tack (gf) | >1000 |
| 180° Degree Peel (gf/in) | >1000 |
| SAFT (° C.) | 55 |

SYLVAREZ TRM1115 = polyterpene resin (Kraton Corporation)
KAYDOL = mineral oil (Sonneborn, Petrolia, Pennsylvania)
KRATON D1117 = linear styrene-isoprene-styrene block copolymer 17% polystyrene (Kraton Corporation)
CHARFLAM400D = 1,3,5-triazine-2,4,6(1H,3H,5H)-trione and 1,3,5-triazine-2,4,6-triamine at a 1:1 ratio (The St. Louis Group LLC)

TABLE 3

| | Example 3 | Example 4 | | Example 5 | |
|---|---|---|---|---|---|
| PLASTOLYN 290 | 1.2 | 1.0 | | 1.0 | |
| SOLPRENE 1205 | 1.2 | 2.0 | | 2.0 | |
| VECTOR 6241 | 6.7 | 0.0 | | 0.0 | |
| VECTOR 4411A | 0.0 | 5.0 | | 8.0 | |
| CALPRENE 401 | 0.0 | 3.0 | | 3.0 | |
| KRATON D1124 | 0.0 | 3.0 | | 3.0 | |
| IRGANOX 1076 | 0.5 | 0.5 | | 0.5 | |
| IRGANOX 1010 | 0.0 | 0.5 | | 0.5 | |
| CALSOL 5550 | 13.4 | 16.2 | | 16.2 | |
| TAIPOL 7126 | 0.0 | 3.0 | | 0.0 | |
| ESCOREZ 5600 | 20.3 | 22.3 | | 22.3 | |
| SOLPRENE 411 | 7.6 | 0.0 | | 0.0 | |
| FINAPRENE 401 | 3.0 | 0.0 | | 0.0 | |
| ESCOREZ 5400 | 19.7 | 22.3 | | 22.3 | |
| ENDEX 160 HC | 2.9 | 0.0 | | 0.0 | |
| SYLVALITE RE100L | 0.0 | 5.0 | | 5.0 | |
| PHOSGARD 200 | 4.1 | 3.0 | | 3.0 | |
| PHOSGARD 300 | 3.3 | 1.0 | | 1.0 | |
| EXOLIT OP 1311 | 5.9 | 5.0 | | 5.0 | |
| EXOLIT OP 935 | 5.9 | 4.0 | | 4.0 | |
| EXOLIT OP 945 | 2.9 | 1.0 | | 1.0 | |
| FIREBRAKE ZB | 1.3 | 1.0 | | 1.0 | |
| CHARFLAM 400 | 0.0 | 1.0 | | 1.0 | |
| Viscosity at 177° C. | 7740 | 3300 | | 2700 | |
| (cP) | | | | | |
| Loop Tack (gf/in) | 2400 | 2400 | | 1500 | |
| 180 Degree Peel | 2100 | 2500 | | 2300 | |
| PET/PET(gf/in) | | | | | |
| 180 Degree Peel | ND | 4000 | gf/in | 3000 | gf/in |
| PET/SS¹ (gf/in) | | 15.44 | N/cm | 11.58 | N/cm |

| | | | | |
|---|---|---|---|---|
| 180 Degree Peel | ND | 145 | gf/in | ND |
| PET/MICA² (gf/in) | | 0.56 | N/cm | |
| 90 Degree Peel | ND | 300 | gf/in | ND |
| MICA/PU³ (gf/in) | | 116 | N/cm | |

| | | | |
|---|---|---|---|
| SAFT (° C.) | 68 | 68 | 68 |
| Flammability I: UL 94 | Pass | Pass | Pass |
| V0 | | | |
| Flammability II: UL | Pass | Pass | Pass |
| 510A | | | |

EXOLIT OP 1311 = phosphinate flame retardant system (Clariant Plastics & Coatings)
EXOLIT OP 935 = phosphinate fine grain powder (Clariant Plastics & Coatings)
VECTOR 4411A = linear styrene-isoprene-styrene block copolymer Dexco Polymers, TSRC Corporation (Taiwan)
CALPRENE 401 = styrene-butadiene-styrene block copolymer (Dynasol Group, Houston, Texas)
KRATON D1124 = styrene-isoprene radial block copolymer (Kraton Corp., Houston, Texas)
TAIPOL 7126 = maleic anhydride modified styrene-ethylene/butylene/styrene linear triblock copolymer TSRC Corporation (Taiwan)
SYLVALITE RE100L = rosin ester (Kraton Corp.)
CHARFLAM 400 = intumescent flame retardant (St. Louis Group LLC, (Indianapolis, Indiana)
¹= The sample was tested according to the 180 Degree Peel Test method with the exception that the first substrate was polyethylene terephthalate (PET) and the second substrate was stainless steel (SS).
²= The sample was tested according to the 180 Degree Peel Test method with the exception that the first substrate was polyethylene terephthalate (PET) and the second substrate was a mica sheet.
³= The sample was tested according to the 90 Degree Peel Test method with the exception that the first substrate was a MICA sheet (MICA) and the second substrate was a polyurethane foam pad.

Other embodiments are within the claims. The documents referred to herein by reference are incorporated to the extent they do not conflict.

1. A flame-retardant hot melt pressure sensitive adhesive composition comprising:
styrenic block copolymer;
tackifying agent;
phosphinic acid salt; and
polyphosphate;
the flame-retardant hot melt pressure sensitive adhesive composition passing the Flammability I and Flammability II test methods.

2. A flame-retardant hot melt pressure sensitive adhesive composition comprising:
styrenic block copolymer;
tackifying agent;
phosphinic acid salt; and
polyphosphate,
the hot melt pressure sensitive adhesive composition exhibiting a viscosity no greater than 20,000 centipoise at 177° C.

3. The flame-retardant hot melt pressure sensitive adhesive composition of claim 1, wherein the polyphosphate comprises a polyphosphate having a melting point no greater than 120° C.

4. The flame-retardant hot melt pressure sensitive adhesive composition of claim 1, wherein the polyphosphate comprises a first polyphosphate and a second polyphosphate different from the first polyphosphate, the second polyphosphate having a melting point no greater than 120° C.

5. The flame-retardant hot melt pressure sensitive adhesive composition of claim 1, wherein the phosphinic acid salt comprises organic phosphinate salt.

6. The flame-retardant hot melt pressure sensitive adhesive composition of claim 1, wherein the phosphinic acid salt comprises a diethyl phosphinate salt.

7. The flame-retardant hot melt pressure sensitive adhesive composition of claim 1 further comprising a intumescent agent, the intumescent agent being different from the polyphosphate.

8. The flame-retardant hot melt pressure sensitive adhesive composition of claim 7, wherein the polyphosphate comprises ammonium polyphosphate and the intumescent agent comprises a melamine derived intumescent agent.

9. The flame-retardant hot melt pressure sensitive adhesive composition of claim 1 further comprising a component selected from the group consisting of metal oxide, carbon black, expandable graphite, and combinations thereof.

10. The flame-retardant hot melt pressure sensitive adhesive composition of claim 1, wherein the styrenic block copolymer comprises radial styrenic block copolymer, maleic anhydride modified styrene-ethylene-butylene-styrene block copolymer, or a combination thereof.

11. The flame-retardant hot melt pressure sensitive adhesive composition of claim 1, comprising
from 5% by weight to 35% by weight styrenic block copolymer;
from 5% by weight to 40% by weight phosphinic acid salt;
from 3% by weight to 40% by weight polyphosphate; and
from 10% by weight to 65% by weight tackifying agent.

12. The flame-retardant hot melt pressure sensitive adhesive composition of claim 1, comprising
from 10% by weight to 30% by weight styrenic block copolymer;
from 5% by weight to 30% by weight phosphinic acid salt;
from 5% by weight to 30% by weight polyphosphate; and
from 10% by weight to 65% by weight tackifying agent,
the composition further comprising from 5% by weight to 30% by weight plasticizer.

13. The flame-retardant hot melt pressure sensitive adhesive composition of claim 1, comprising
from 10% by weight to 30% by weight styrenic block copolymer, wherein the styrenic block copolymer comprises a radial block copolymer;
from 5% by weight to 30% by weight phosphinic acid salt;
from 5% by weight to 30% by weight polyphosphate; and
from 10% by weight to 65% by weight tackifying agent,
the composition further comprising
an intumescent agent different from the polyphosphate; and
from 5% by weight to 30% by weight plasticizer.

14. The flame-retardant hot melt pressure sensitive adhesive composition of claim 1, comprising
from 10% by weight to 30% by weight styrenic block copolymer, wherein the styrenic block copolymer comprises a radial block copolymer;
from 5% by weight to 30% by weight phosphinic acid salt;
from 5% by weight to 30% by weight polyphosphate; and
from 10% by weight to 65% by weight tackifying agent,
the composition further comprising
from 5% by weight to 30% by weight plasticizer;
an intumescent agent different from the polyphosphate; and
a flame retardant selected from the group consisting of metal oxide, carbon black, and combinations thereof.

15. The flame-retardant hot melt pressure sensitive adhesive composition of claim 14, wherein
the polyphosphate comprises a first polyphosphate and a second polyphosphate different from the first polyphosphate, the second polyphosphate having a melting point no greater than 120° C., and
the intumescent agent is different from the first polyphosphate and the second polyphosphate.

16. The flame-retardant hot melt pressure sensitive adhesive composition of claim 1, wherein the sum of the weight of the phosphinic acid salt and the weight of the polyphosphate is no greater than 40% by weight based on the weight of the flame-retardant hot melt pressure sensitive adhesive composition.

17. The flame-retardant hot melt pressure sensitive adhesive composition of claim 1, wherein the sum of the weight of the phosphinic acid salt and the weight of the polyphosphate is no greater than 30% by weight based on the weight of the flame-retardant hot melt pressure sensitive adhesive composition.

18. The flame-retardant hot melt pressure sensitive adhesive composition of claim 1, wherein the composition exhibits a peel force of at least 1.16 N/cm when tested according to the 180 Degree Peel Adhesion test method, a maximum debonding force of at least 2.94 N when tested according to the Loop Tack test method, a shear adhesion failure temperature of at least 50° C. a viscosity no greater than 8000 cP at 177° C., or a combination thereof.

19. A process for applying a flame-retardant hot melt pressure sensitive adhesive composition on a battery cell, the process comprising:
releasing the flame-retardant hot melt pressure sensitive adhesive composition of claim 1 from an applicator head in the form of a spray; and
forming an adhesive coated surface on a surface of a first battery cell, the forming comprising contacting the surface of a battery cell with the spray of the flame-retardant hot melt pressure sensitive adhesive composition without the applicator head contacting the surface of the battery cell.

20. A battery cell array comprising:
a first battery cell;
a second battery cell; and
the flame-retardant pressure sensitive hot melt adhesive composition of claim 1,
the first battery cell being adhered to the second battery cell through the flame-retardant pressure sensitive hot melt adhesive composition.
